(19) United States
(12) Patent Application Publication
(10) Pub. No.: US 2008/0124480 A1
(43) Pub. Date: May 29, 2008

(54) FREE LAYER BLADE DAMPER BY MAGNETO-MECHANICAL MATERIALS

(76) Inventor: Mo-How Herman Shen, Dublin, OH (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 11/736,093

(22) Filed: Apr. 17, 2007

Related U.S. Application Data
(63) Continuation-in-part of application No. 11/215,195, filed on Aug. 30, 2005, now abandoned.
(60) Provisional application No. 60/606,890, filed on Sep. 3, 2004.

(51) Int. Cl. C23C 4/08; B05D 1/00; B32B 15/01

(52) U.S. Cl. 427/456; 427/250; 428/615

(57) ABSTRACT

A coating for an article is provided to enhance vibration damping and fatigue strength, without diluting resistance to erosion, wear, and corrosion for metallic components such as blades, blisks, shafts and bearings of a gas turbine engine operating in a hostile environment. The invention includes a metallic substrate and a thin layer of magneto-mechanical material bonded to the surface of the substrate by a coating process. The coating material is made of the Fe—Cr—Al or Fe—Cr—Mo based magneto-mechanical materials and deposited to the surface of the substrate via a thermal spraying process in vacuum or in air. In order to achieve maximum damping capability and resistance to erosion, wear, and corrosion, several optimal compositions of the coating material in conjunction with new application methods have been developed. The coating is often very thin and smooth in order not to dilute aerodynamic efficiency and fatigue strength. The thin layer of magneto-mechanical material can also be applied and bonded to the substrate by a variety of methods, for example using a self-adhesive foil, made by Fe—Cr—Al or Fe—Cr—Mo alloys, on the surface of the substrate and via thermal spraying or physical vapor deposition processes.

### RELATED APPLICATION

This application is a Continuation-in-Part of my co-pending U.S. patent application Ser. No. 11/215,195 filed Aug. 30, 2005, now abandoned, which in turn claimed priority to and the benefit of U.S. Provisional Patent Application No. 60/606,890 filed Sep. 3, 2004.

### GOVERNMENT RIGHTS

Part of the invention herein described was made in the course of or under a contact with the U.S. Department of the Navy.

### FIELD OF THE INVENTION

This invention relates to protective coatings applied and/or bonded to the surface of metallic substrates for enhancing vibration damping, resistance to erosion, wear, and corrosion of the substrate. More specifically, this invention is directed to the development of hard metal coating systems for improving durability, reliability, and safety of gas turbine components which are usually operated under severe hostile conditions.

### BACKGROUND OF THE INVENTION

Most load-carrying structural systems such as aircraft gas turbine engines are usually under severe operating conditions. These types of structures demand durability, high reliability, light weight, and high performance. Therefore, lifetime failure-free design criteria based on the Goodman Diagram and Miner's rule have been adopted by the structural design community for ensuring safety of critical structural components. These design criteria, design guides, or design codes are usually established using the results of a simple deterministic analysis procedure without taking into account the information such as degradation of material properties, scatter in testing data, previous successful design experience, and uncertainties inherent in the operating conditions in the real world. In turn, as it has been reported, a number of structural failures have occurred in those critical structural components during development testing and operational service. These incidents triggered an awareness of the fact that although current critical structural components satisfy the lifetime failure-free design criteria they do sometimes fail, gas turbine rotating components or blades in particular.

Among these failures, the Sioux City incident is one of the most famous examples. Although the Sioux City incident was caused by a material defect during the manufacturing process, high cycle fatigue of blades in jet engines is often the major concern in aviation safety, especially in high performance military jets. High cycle fatigue directly causes blade cracking, which increases maintenance and inspection costs, reduces operational readiness, and sometime even results in the loss of the aircraft and crews. In 1999, the Air Force spent roughly one third of its total maintenance expenses on high cycle fatigue incidents. According to their records, there were at least two F-16 fighter crashes related to high cycle fatigue incidents in that year. One was caused by a catastrophic failure in high pressure turbine assembly when two turbine blades separated due to high cycle fatigue. The other incident was caused by first stage compressor failure when one compressor blade broke away due to high cycle fatigue. In this incident, an ultrasound inspection test had been performed on that particular engine, but still failed to detect the developing crack.

In another incident recently released on Jan. 6, 2004 from U.S. Air Force officials, failure of a turbine blade caused an F-16C to crash in an unpopulated area near Rosepine, La., on Sep. 22, 2003. The aircraft, assigned to the 147th Fighter Wing, Ellington Field, Houston, Tex., was part of a six-ship, unopposed surface attack training mission. According to the Aircraft Investigation Board report, the engine turbine blade failed due to fatigue though there were no external signs of excess fatigue during routine inspections. The value of aircraft and equipment lost totaled about $23.3 million, according to the Air Force officials.

Recently, a newly designed Navy F/A-18E Super Hornet fighter was grounded due to the compressor blade failure of its new 22,000 lb thrust General Electric (GE) engine. After a thorough examination, fatigue cracks were found near the tip of two compressor blades. A root cause analysis by the Navy pinpointed the cause of this cracking problem as primarily due to high cycle fatigue. This vibratory multiaxial stresses, as shown in FIGS. 1 and 2, induced fatigue cracking problem was directly caused by the extreme maneuvering the aircraft involved during its testing procedure. Unfortunately, extreme maneuvering is one of the activities that military fighters cannot avoid during training and combat missions. This makes avoiding high cycle fatigue problems a high priority in the new integrated high performance turbine engine technology (IHPTET) program. Therefore, preventing jet engine blade failures caused by high cycle fatigue is one of the major objectives of current engine design and in-service maintenance.

To prevent blade failure, the excited resonant response needs to be attenuated to an acceptable level. Several investigators have presented approaches to suppress blade vibration by providing additional damping through blade dampers. For example, dry friction dampers that include blade-to-ground, blade-to-blade, and shroud dampers are the most common vibration suppression devices employed by aircraft engine designers. However, it is well known that the structural damping from dry friction dampers and from aero-damping are negligible for high frequency vibration; and the dominant damping of the blades results from the energy dissipation in the material. Consequently, low material damping results in high vibratory stress, increased failure risk, and significantly reduced reliability and safety. This has motivated recent activities of high frequency damper designs associated with tuned-mass or particle, air cavity, shape memory alloy, etc. (as described in U.S. Pat. Nos. 5,498,137; 5,820,348; 5,924,845; 6,514,040; 6,547,049; 6,796,408; and 6,827,551).

Recently, numerous investigations (as described in Kielb et al, “Advanced Damping Systems for Fan and Compressor and Blisks,” 1999 Proceedings of 4^{th} National Turbine Engine High Cycle Fatigue Conference, also described in U.S. Pat. No. 6,471,484) have been undertaken regarding the integration of viscoelastic damping materials into rotating blades for the purpose of reducing vibratory stresses in high frequency stripe modes. The additional vibratory energy dissipation is accomplished through high internal friction in viscoelastic material patches inserted into milled cavities, which are sealed with a coversheet to maintain the structural integrity and the original airfoil contour. In addition to the temperature limitation of viscoelastic damping materials, such damping patches on blades could lead to manufacturing and durability concerns. I believe that a surface high-damping coating layer is likely to be more practical.

Cross, Lull, Newman, and Cavanagh (as described in Journal of Aircraft, 1973 vol. 10, pp. 685-687, also described in U.S. Pat. Nos. 3,301,530 and 3,758,233) presented a method using several alternative candidate materials as graded plasma ceramic coatings on aluminum blades to obtain higher structural damping. Their test data demonstrated the use of three to six layered coatings of such materials as magnesium aluminate, molybdenum, and Hastelloy-X, to enhance the structural damping of the blades. This multi-layered coating system can be very expensive and difficult to be implemented to real engine hardware. Particularly, the interface degradation, caused by the mismatching of material properties between the ceramic coating layers and metal blade and with one another, leads to weaker interface strength and often reduces the fatigue lifetime tremendously. Furthermore, both time-consuming and costly manufacturing process and the weight of the coating layers dilute its potential for real world applications.

Another ceramic coating system used to enhance vibration damping in metallic articles is shown in U.S. Pat. No. 6,059,533, where a shot peened metallic substrate shaping the blade is bonded to its outside surface by a singular ceramic coating of a damping material. The metallic substrate can be formed of forged titanium for the blade and is shot peened all over before the single layer of damping ceramic coating is applied on outside surface. However, the interface degradation, caused by the mismatching of material properties between the ceramic and metals, could lead to weaker interface strength and often reduces the high cycle durability tremendously. Additionally, hard and rough ceramic coating surface can affect aerodynamic efficiency. Furthermore, ceramic coatings in general have poor resistance to erosion or foreign object damage.

A very similar damping coating system has been recently described in U.S. Pat. Application No. 2004/0096332, where a metal is used as the predominant of an outermost portion of a ceramic-containing and metal-containing damping coating. Hence, wherein the coating consists essentially of one ceramic vibration damping layer and one metallic outermost layer. However, the interface degradation, caused by the mismatching of material properties between the ceramic and metals, leads to weaker interface strength and often reduces the fatigue lifetime tremendously. Furthermore, low erosion resistant capability, high cycle durability concerns, and costly manufacturing process significantly reduce its potential for real world applications, blading systems in particular.

Additionally, the following publications should be examined in order to put the present invention into proper context:
1. Y. Yen and M.-H. Herman Shen, 1998, “Passive Vibration Suppression of Beams Using Magnetomechanical Coating”, Vibration and Noise Control, DE-Vol. 97/DSC-Vol. 65, ASME.
2. Y. Yen and M.-H. Herman. Shen, 1999 “Passive Vibration Suppression of Turbine Blades Using Magnetomechanical Coating”, 4th National Turbine Engine High Cycle Fatigue Conference.
3. H. Y. Yen and M.-H. Herman Shen, 2000, “Magnetomechanical Coating Applications in Vibration Suppression of Turbine Blades”, 5th National Turbine Engine High Cycle Fatigue Conference.
4. H. Y. Yen and M.-H. Herman Shen, 2000-GT-366, “Development of a Passive Turbine Blade Damper Using Magnetomechanical Coating” proceeding of ASME International Gas Turbine & Aeroengine Congress, & Exhibition.
5. H. Y. Yen and M.-H. Herman Shen, 2001 “Passive Vibration Suppression of Turbine Blades Using Magnetomechanical Coating”, Journal of Sound and Vibration, Vol. 245, no. 4, pp. 701-744.
6. M.-H. Herman Shen, 2002, “Development of a Free Layer Damper using Hard Coatings”, 7th National Turbine Engine High Cycle Fatigue Conference.
7. Herman Shen, 2005, “Free Layer Damper by Magneto-Mechanical Coating”, 10th National Turbine Engine High Cycle Fatigue Conference.
8. Herman Shen, 2006, “Free Layer Damper by Magneto-Mechanical Coating—Phase II”, 1st Propulsion-Safety and Affordable Readiness Conference.

Among all these high frequency damper designs, a novel free layer blade damper I developed is likely to be more practical and overcomes almost all the concerns addressed above. The invention includes applying a thin layer of the Fe—Cr—Al or Fe—Cr—Mo based magneto-mechanical coatings (as described by A. Karimi in Journal of Magnetism and Magnetic Materials, Vol. 215-216, 2000, pg. 601-603) on a metal substrate, such as a turbine blade, for enhancing vibration damping, without diluting surface properties of the substrate associated with resistance to wear, erosion, fatigue, and corrosion. The goal of the effort was to explore all the possibilities that this new damping coating system can achieve and lay down a solid theoretical and experimental foundation and framework on the fully realized implementation of this novel technology. The successful completion of the effort has already proved that the novel coating system is an effective solution providing significant damping to blades/blisks/IBRs at all vibration modes.

The coating system (Fe-16Cr—X) used in this invention has some similarity to the widely used MCrAlY coating systems described in U.S. Pat. Nos. 6,207,297; 6,387,527; 6,410,159; 6,921,582; and U.S. Patent Application 2004/234,808. Typical MCrAlY coatings contain at least 4 elements (M-Cr—Al—Y) where M stands for either nickel (Ni) or cobalt (Co) or a combination of the two. The presence of 10 wt % or higher provides much better capability in resisting corrosion combined with good oxidation resistance. Al content in MCrAlY coatings is typically around 12 wt % which usually gives the coatings excellent oxidation resistance and Y is yttrium only around 1 wt % in MCrAlY coatings. Typical MCrAlY coating is generally deposited by plasma spraying or electron beam physical vapour deposition.

Therefore, the property in high resistance to high-temperature oxidation and corrosion makes MCrAlY coatings widely used to meet the increasing demands in power generation boilers, electric furnaces, and gas turbine engines to restrict the surface degradation. Significant cost and performance improvements are obtained by application of such coatings. However, prior art literature does not indicate MCrAlY coatings have been used for enhancing vibration damping in any applications nor have any damping mechanism of MCrAlY coatings have been identified.

### SUMMARY OF THE INVENTION

The present invention includes a metallic substrate and a thin layer of magneto-mechanical material bonded to the surface of the substrate by a single thin coating layer. The coating material is made of the Fe—Cr based magneto-mechanical materials and deposited to the surface of the substrate via a thermal spraying process in vacuum or in air. In order to achieve maximum damping capability and resistance to erosion, wear, and corrosion, several optimal compositions of the coating material in conjunction with a new coating powder fabrication process and novel application methods have been developed. The coating is often very thin and smooth in order not to dilute aerodynamic efficiency and fatigue strength. The thin layer of magneto-mechanical material can also be applied and bonded to the substrate by a variety of methods, for example using a self-adhesive foil, made by Fe—Cr—Mo based alloys, on the surface of the substrate.

Additional damping is achieved through internal friction via the magneto-elastic effects caused by stress or strain-induced irreversible movement of magnetic domain walls. According to the domain theory (A. W. Cochardt, 1953, “The Origin of Damping in High-Strength Ferromagnetic Alloys,” Journal of Applied Mechanics, Vol. 20, pp. 196-200), the domain walls of the Fe—Cr based materials or ferromagnetic materials in general rotate and generate a higher magnetic field strength under external loading. As the loading is removed, the domain walls rotate to a different pattern, which corresponds to a lower magnetic field strength. This process has been observed and shown to produce a significant amount of magneto-mechanical hysteresis energy loss which in turn may improve damping. Several experimental studies have shown that this magneto-mechanical damping is stress or strain dependent. In other words, the damping capability (characterized as loss factory η or Q⁻¹) of the Fe—Cr based materials/alloys is a function of vibratory stress or strain of the materials/alloys under external dynamical loading.

This invention, a new vibration damper using a thin layer of the Fe—Cr—Al or Fe—Cr—Mo based alloy, can be applied to the surface of metallic substrates (e.g. turbine blades) to enhance vibration damping, resistance to foreign object damage or erosion, resistance to wear, and resistance to corrosion of the substrate. The alloys are made from raw materials of 99.9% purity in high frequency induction furnace in vacuum. The additional damping is achieved through internal friction via the magneto-elastic effects caused by stress or strain-induced irreversible movement of magnetic domain walls. The high corrosion resistance is contributed from the raw material Cr and resistance to erosion and wear is a basic engineering property of raw material Fe. In accordance with ASTM standard testing procedure, the mechanical properties of the damping alloys have been determined where Young's modulus is 2.82E+07 psi and Poisson's ratio is equal to about 0.3-0.32. The thin layer vibration damper is capable of being operated at high temperature (up to but not limited to 1000° F.) condition and high vibration frequency range (up to but not limit to 20,000 Hz).

Two novel surface deposition methods/procedures may be used to form the thin damping layer. In the first method, the thin damping layer is built via a coating process. The coating powder is made of the Fe—Cr—Al or Mo alloys and deposited to the surface of the substrate via a special thermal spraying process in vacuum or in air. In the second method, the thin damping layer is built with a thin self-adhesive foil, made by Fe—Cr—Al or Mo alloys, directly adhered on one surface to a substrate such as a turbine blade. A new finite element based analytical procedure may be used for modeling the dynamic behavior of substrate coated with the plasma-sprayed Fe—Cr based coatings. The effects of coating on the forced response of coated substrates can be determined via the procedure.

### BRIEF DESCRIPTION OF THE DRAWING FIGURES

FIG. 1 is an analytical prediction of high order mode shapes of an uncoated cantilevered blade;

FIG. 2 is an analytical prediction of vibratory von-Moses stresses at 3^{rd} and 4^{th} stripe modes of an uncoated blade at the modes as shown FIG. 1;

FIG. 3 illustrates the test results in frequency response (2^{nd} bending mode) with respect to shaker acceleration of a Fe-16Cr-3Al beam specimen;

FIG. 4 illustrates the test result for determining Young's Modulus of the Fe-16Cr-4Mo alloy: E=2.82×10⁷ psi;

FIG. 5 illustrates the test result of a small compressor blade at a lower order mode (˜2,000 Hz): uncoated (bottom plot) blade and coated (top plot) blade coated with a thin coating layer (0.002 in);

FIG. 6 illustrates the test result of the small compressor blade at high order; mode #1 (˜5,000 Hz): uncoated (bottom plot) blade and coated (top plot) blade coated with a thin coating layer (0.002 in);

FIG. 7 illustrates the test result of the small compressor blade at high order mode #2 (˜8,000 Hz): uncoated (bottom plot) blade and coated (top plot) blade coated with a thin coating layer (0.002 in);

FIG. 8 illustrates the test result of the small compressor blade at high order mode #3 (˜20,000 Hz): uncoated (bottom plot) blade and coated (top plot) blade coated with a thin coating layer (0.002 in);

FIG. 9 illustrates the test result of a large compressor blade at second bending mode (˜1,200 Hz): uncoated (top plot) blade and coated (bottom plot) blade coated with a thin coating layer (0.003 in);

FIG. 10 illustrates the test result of the large compressor blade at a high order mode (˜17,000 Hz): uncoated (top plot) blade and coated (bottom plot) blade coated with a thin coating layer (0.003 in);

FIG. 11 is an analytical prediction of vibratory von-Moses stresses at 3^{rd} and 4^{th} stripe modes of a cantilevered blade coated with a thin layer of Fe—Cr based coating on the pressure side only; and

FIG. 12 illustrates the test result of fatigue strength assessment diagram: S-N curves axial and bending.

### DETAILED DESCRIPTION OF THE INVENTION

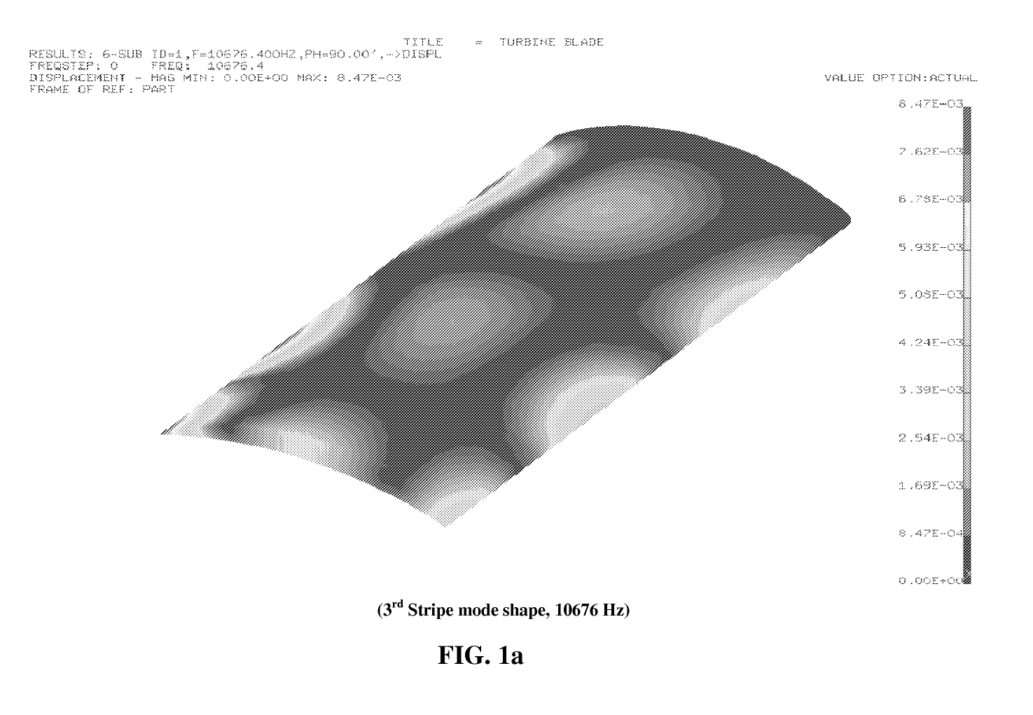

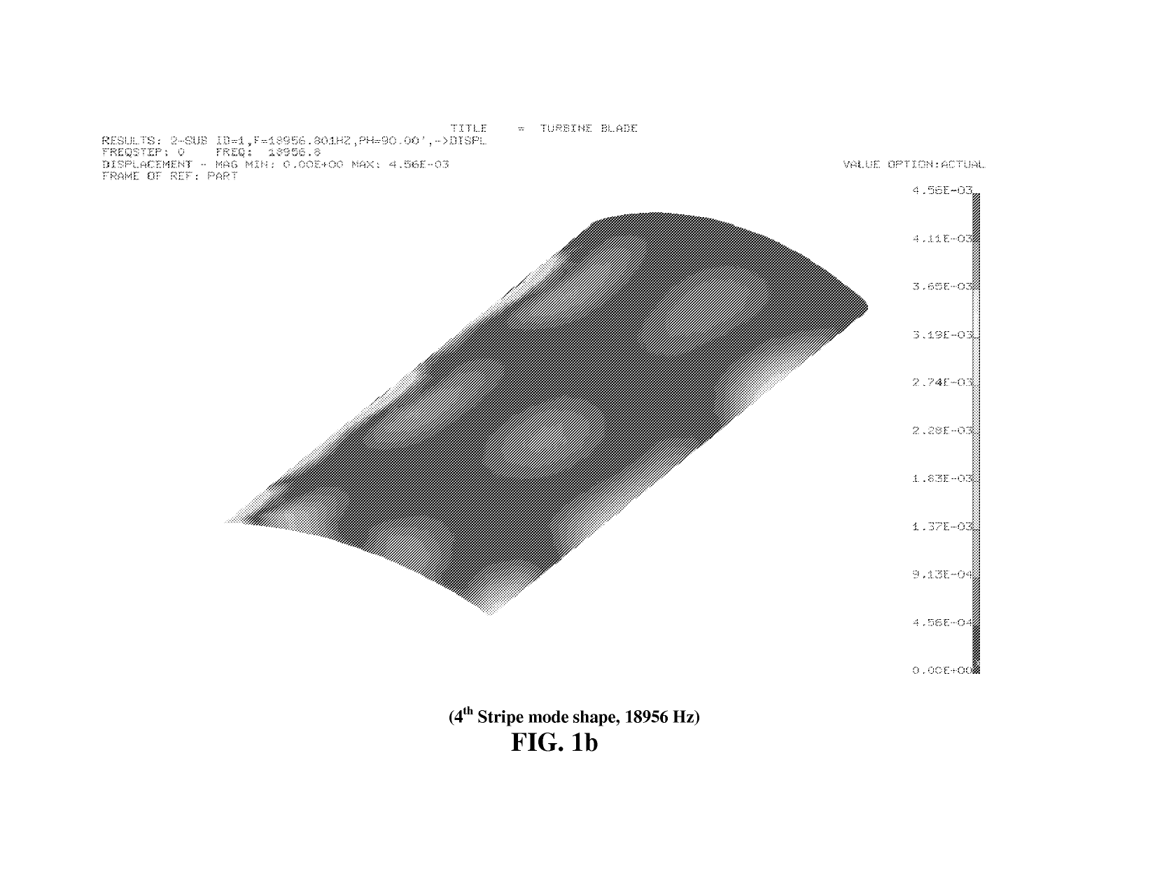

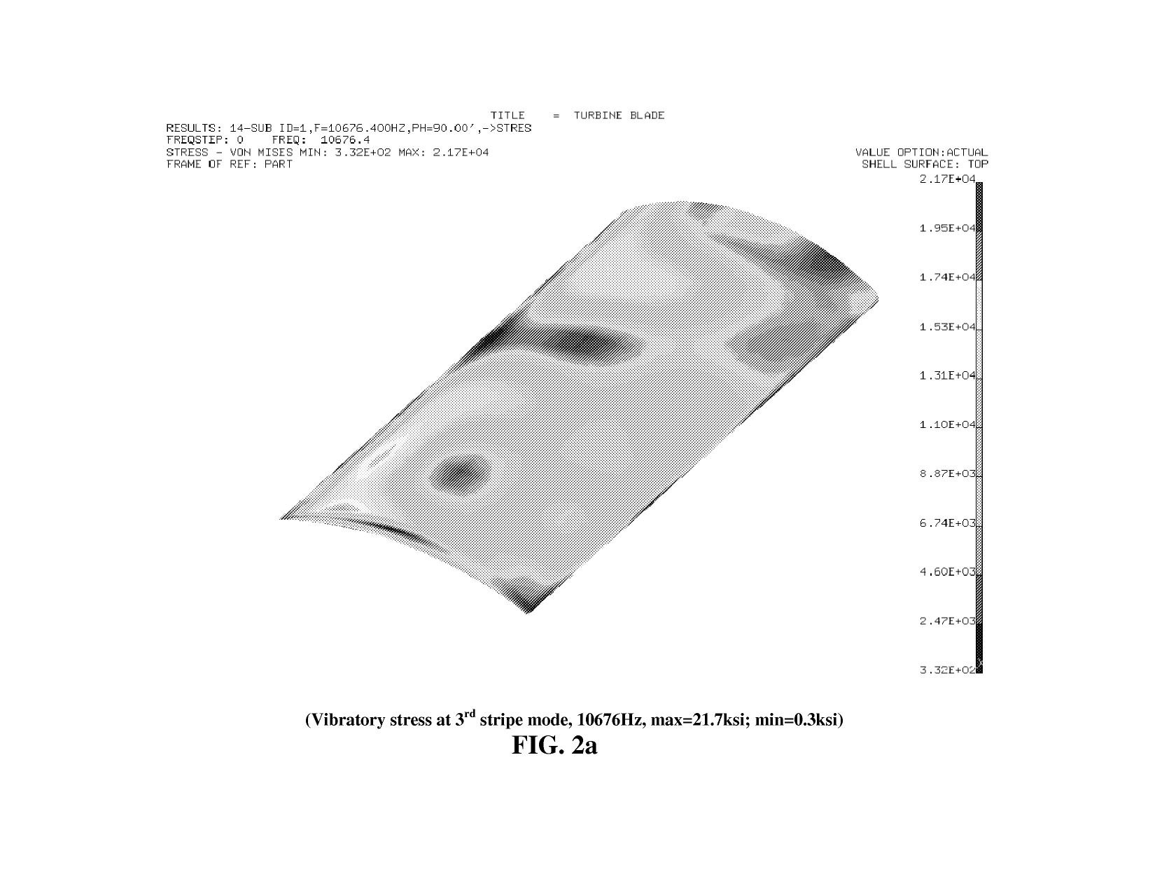

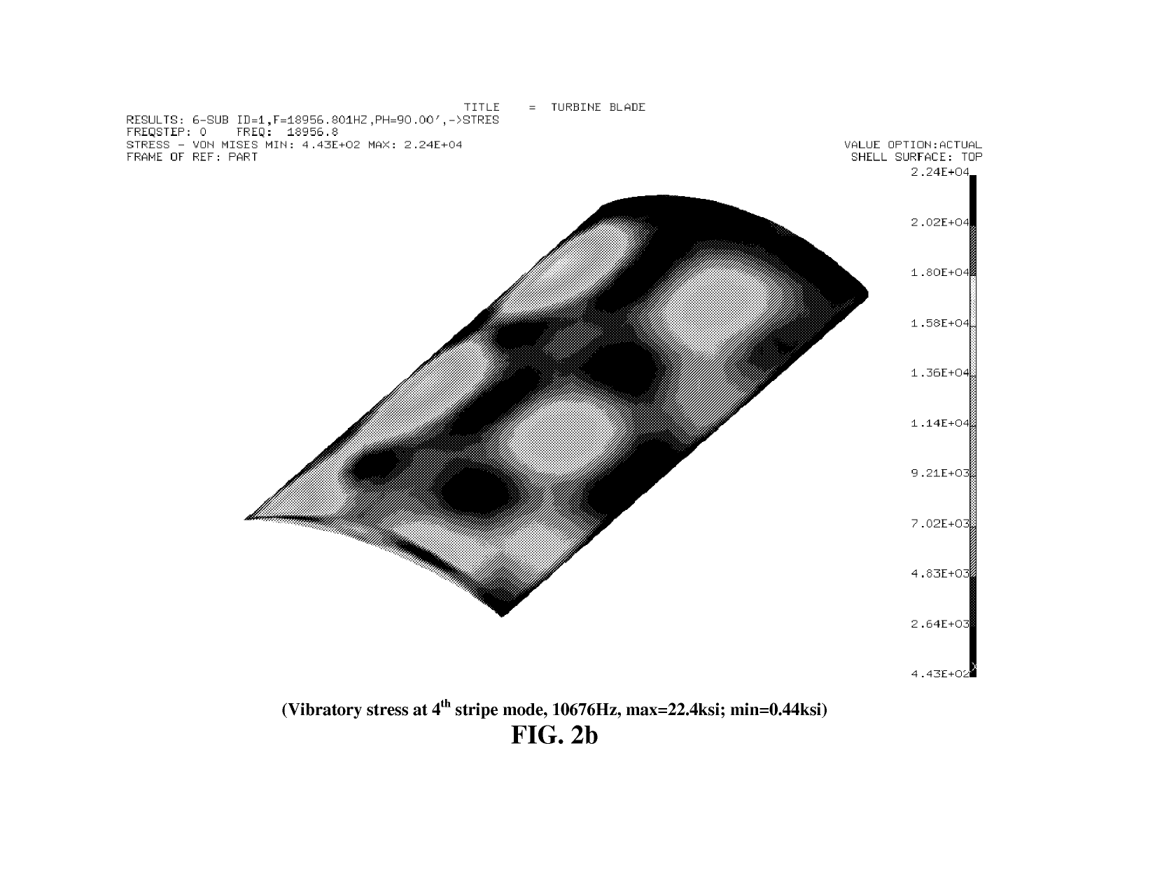

This invention relates to a new vibration damper using a thin layer of the Fe—Cr—Al or Fe—Cr—Mo based material applied to the surface of metallic substrates (e.g. turbine blades) to enhance vibration damping, resistance to foreign object damage or erosion, resistance to wear, and resistance to corrosion of the substrate. More particularly, the thin layer vibration damper can be operated at high temperature (at least to 1000° F.) condition and high vibration frequency range (at least to 20,000 Hz). Three important aspects of the invention are:
(1) In order to achieve maximum damping capability, several optimal compositions of the damping material have been developed. In accordance with the study in Journal of Magnetism and Magnetic Materials, Vol. 215-216, 2000, pg. 601-603, the compositions contain a base material in the form of a mixture of Fe and Cr, and an active ingredient of Al or Mo. The weight ratios of Fe—Cr—Al or Mo are Fe-16% Cr-0% Al or Mo to Fe-16% Cr-6% Al or Fe-16%-5% Mo. In addition, Young's modulus and Poisson's ratio, the engineering properties of the alloys, have been determined to be 2.82 E+07 psi and 0.3-0.32, respectively.
(2) Two surface deposition methods or processes have been developed. In the first method, the thin layer damper is built via a coating process. The coating powder is made of the Fe—Cr based materials as described above and deposited to the surface of the substrate via a thermal spraying process in vacuum or in air. Although not required, it may be desirable to apply an adequate heat treatment to the coated substrate to improve the internal stress distribution caused by dislocations, alloying atoms, grain boundaries, and micro-defects. In the second method, a self-adhesive foil, made by Fe—Cr—Mo based alloys as described above, may be adhered to a substrate. In use, the foil is adhered on one surface to a substrate such as a turbine blade to enhance vibration damping as well as to improve capability of resistances to erosion, corrosion, and wear.
(3) A finite element based analytical procedure has been developed for modeling the dynamic behavior of substrate coated with the plasma-sprayed Fe—Cr—X based coatings described above. The effects of coating on the forced response of coated substrates can be achieved via the procedure. For example, analytical procedure can be applied to examine the forced response of coated blades at high frequency third-stripe and fourth-stripe modes as shown in FIG. 1 and FIG. 2. At least ten thousand four-node isoparametric and eight-node solid elements were used to model the coating layer and the blade. The number of elements was chosen to capture the effect of the coating on desired vibration modes or critical frequency range. To cover the fluctuating vibratory stress pattern, the coating was applied to the entire pressure side of the blade and modeled with two-dimensional isoparametric elements. The strain/stress and temperature dependent damping characteristic of the materials described above was also implemented in the finite element model allowing for a temperature dependent forced response evaluation.

### Damping Capability Assessment

Damping Assessments of Beams Made by the Coating Material:

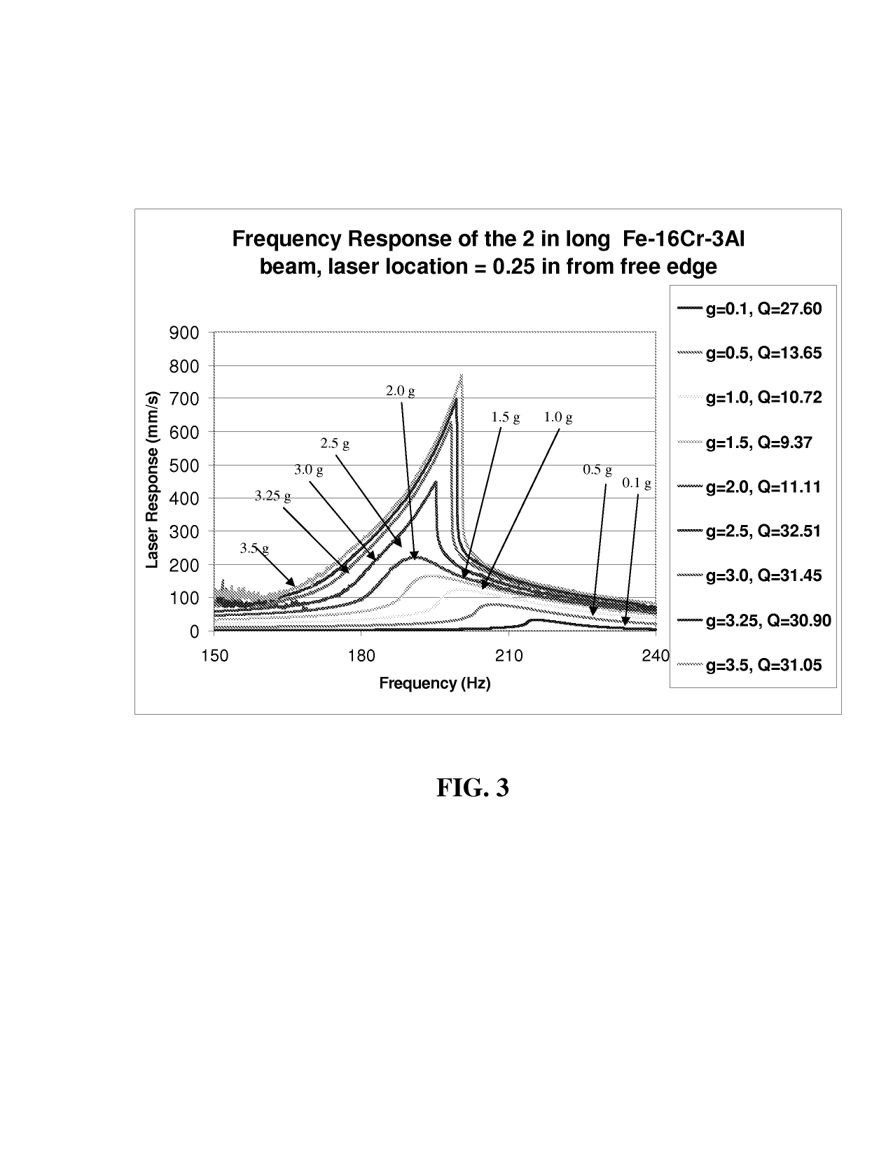

The dependency of the strain or stress amplitude and the damping capability has been carefully evaluated in this invention. A number of vibration modal analyses/tests on a flat polished beam specimen, made substantially entirely from the coating material, has been conducted by the inventor as presented in FIG. 3, respectively. The frequency response results clearly show that the damping capacity of the coating specimen improves as the forcing acceleration increases. However, the damping levels are observed to be stationary at forcing level 3.0 g. Similar behavior can be found in the natural frequency measurements, the resonant frequency of the coating specimen reduces rapidly as the forcing accelerations increases and reaches a stationary value as the forcing level approaching 3.0 g, and then increases relatively slowly to its initial natural frequency.

Damping Assessments of Beams Coated with a Thin Layer of the Coating:

The dependence of the damping capability, in terms of loss factor η (or on vibratory strain amplitude of the coated beams has been determined experimentally and formulated analytically and used in a finite element modeling and analysis process for blades. In order to clearly illustrate the idea, the performance and effectiveness of the free layer blade damper were evaluated and demonstrated by the experimental results from a Hastelloy X beam specimen coated with a thin layer of Fe—Cr based coatings, which was subjected to various exciting forces (0.5 g-2.5 g) and temperature levels (room, 300° F., 600° F., & 900° F.). Significant and very promising results have been achieved which clearly show that the damping can be increased to 200% and displacement or vibratory stresses can be reduced up to 60% of the coated beam. Additionally, the results also clearly indicate that there is no significant change in the damping of the coated beam at high temperatures (up to 1000° F.).

It is important to note that, in this invention, the loss factor or the energy dissipation density per cycle of the coating layer is independent of the vibratory frequency of coated substrates. This frequency independent feature allows this damping system to be capable of enhancing damping significantly at almost all the vibration modes of coated turbine blades, high order stripe modes in particular.

### Mechanical Properties Assessment

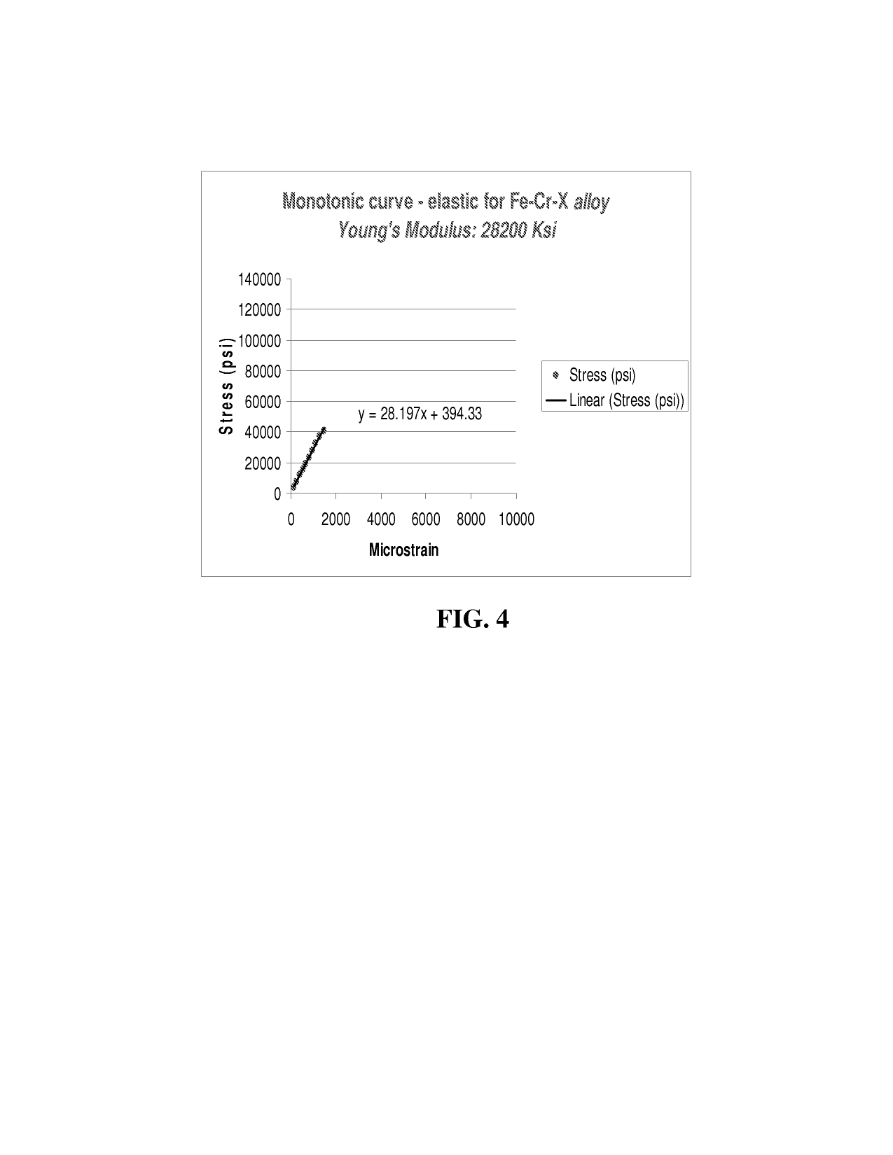

In this invention, mechanical property (Young's modulus and Poisson's ratio) of the Fe—Cr based alloy was determined in accordance with an ASTM standard testing procedure. An axial loading test was conducted on the dog-bone specimen made entirely from the coating material using a MTS servo hydraulic load frame. The specimen is held in place with hydraulic grips and an axial tensile force is applied slowly. As the coating specimen is pulled, the axial load is measured automatically and the axial stress was calculated by dividing the axial load by the cross-sectional area. The data is acquired using a Test Star II station manager. Strain values have been collected in either through the use of an extensometer or a strain gage. Since the load is axial and it's below yielding limit, in accordance with Hooke's law, the slope (2.82 E+07 psi) of the points/line in FIG. 4 is Young's modulus (E) of the Fe—Cr based alloys which shows a close match to the mechanical properties of metallic materials of gas turbine materials, such as Ti-6Al-4V. This suitable matching between the surface damping coating material and the blade material has the advantage of being able to produce good bonding strength in the interface during the coating process.

### Effect of Real-World Characteristics Pertinent to Real Blade Response on Damping

### EXAMPLE NO. 1

### Two Small Gas Turbine Engine Compressor Blades, Uncoated & Coated, Coating Thickness: 0.002 Inch

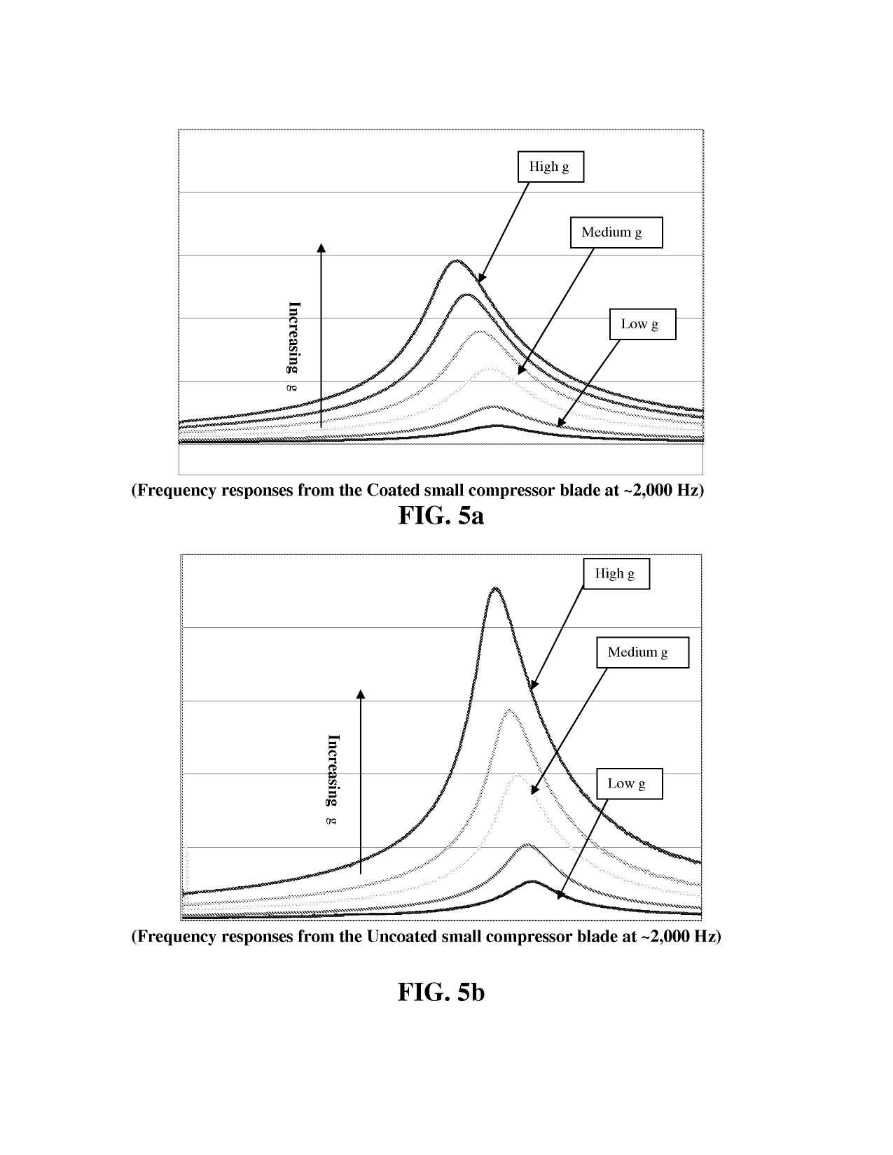

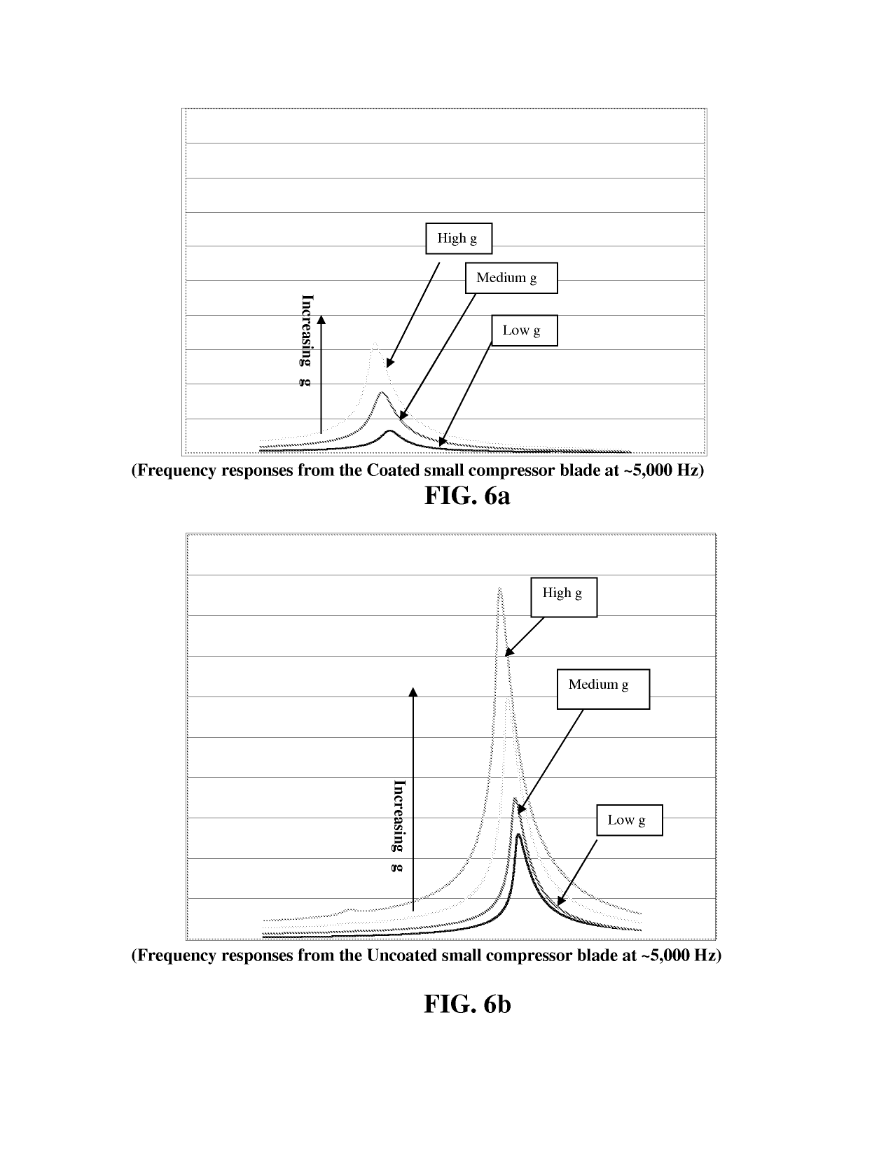

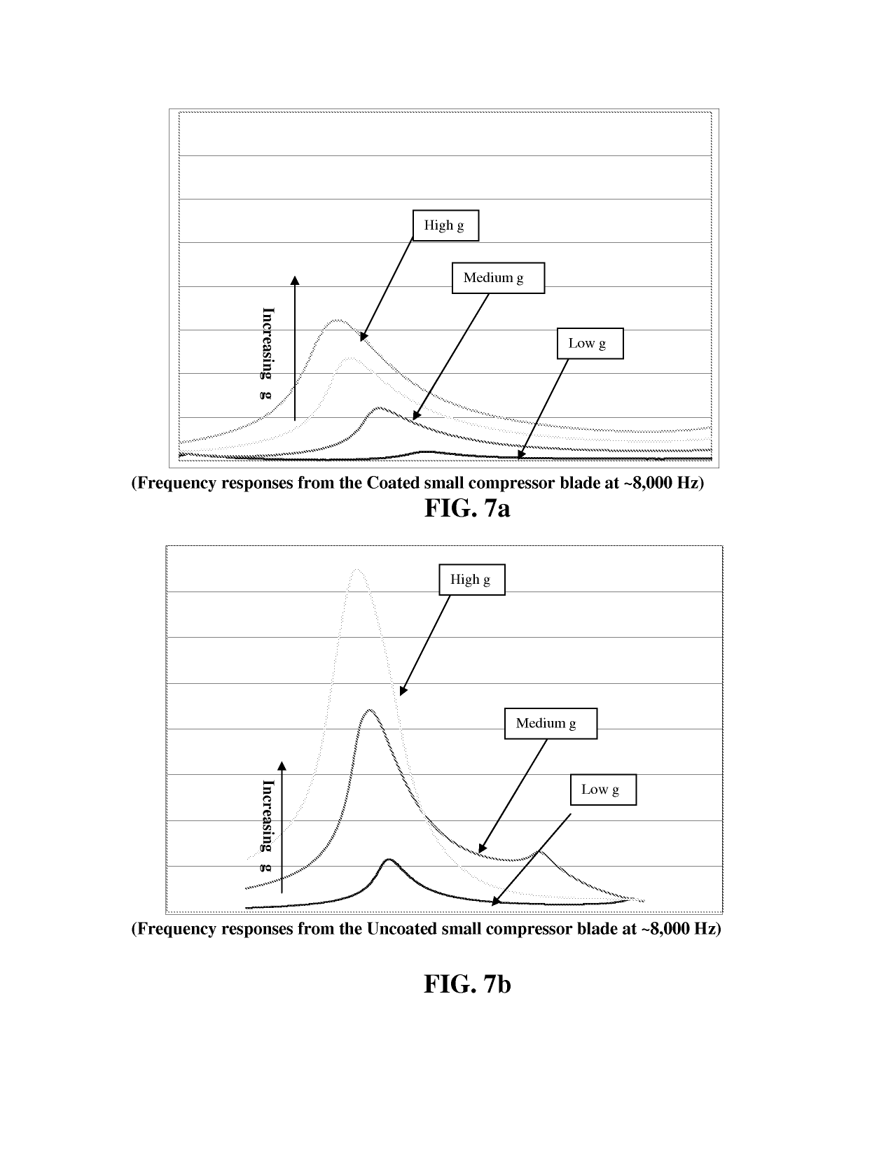

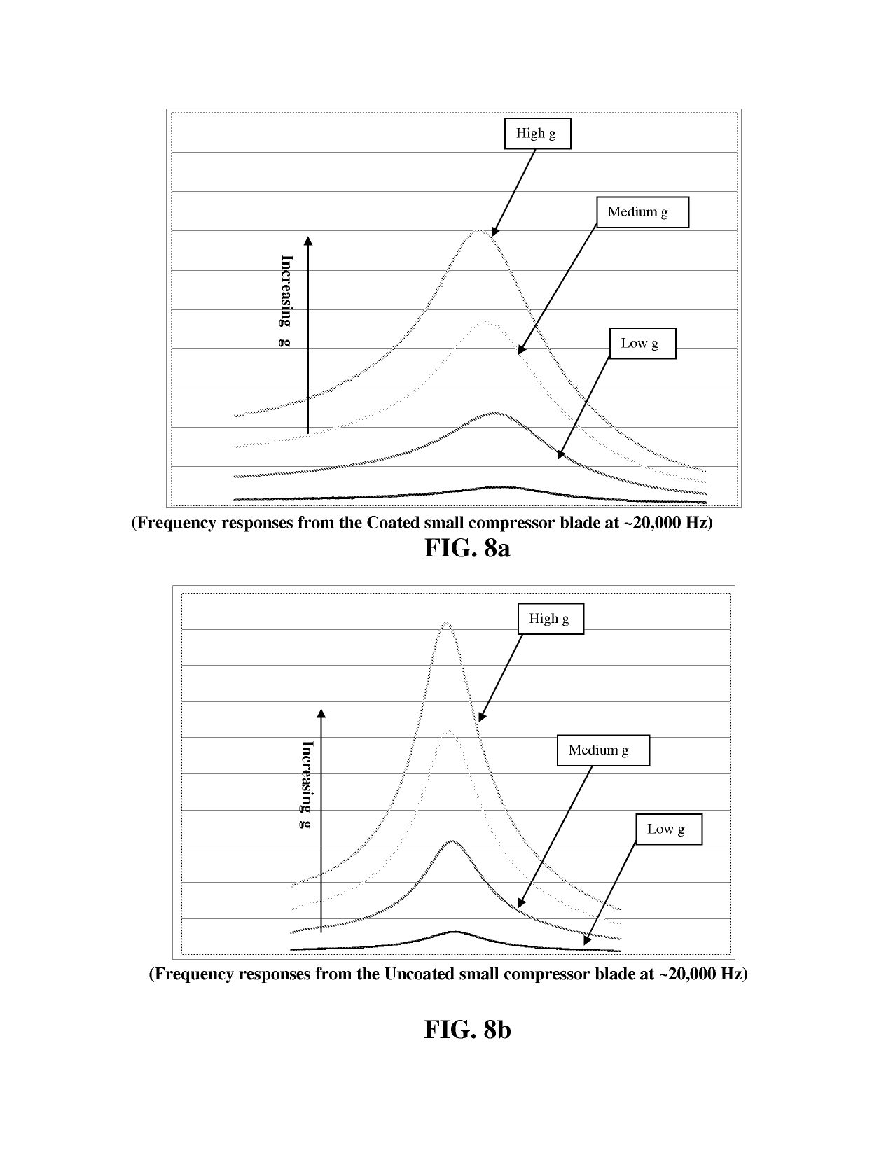

In order to verify that the technology can be implemented to real world applications, the inventor further extended experimentation to real aircraft engine blades (two compressor blades). The inventor simply coated a very thin layer (only 0.002 inch) of the coating to one of the two blades and evaluated the performance of the coating on stress reduction and damping enhancement by using the 18,000 lb. dynamic shaker system. The results shown in FIG. 5, as expected, similar to the coated beam cases, show that the vibratory stress of the coated blade (with 0.002 inch coating layer) was reduced by half (50% reduction) and its damping capability was doubled (100% improvement) in the second mode (natural frequency ˜2,000 Hz). Very promising results, as shown in FIGS. 6-8, were also achieved from the high order modes (natural frequencies around ˜5,000 Hz, ˜8,000 Hz, and ˜20,000 Hz) tests. Several observations can be made from this investigation. First, for a general loading condition, the damping capability of the coated blade can be significantly improved at specific modes and reasonably enhanced at other modes. In turn, the maximum vibratory stresses of the coated blade can be significantly reduced or reasonably suppressed at almost all the modes. Second, in comparing the responses between the coated and uncoated blades, the responses of the coated blade behave in a much more stable manner than the uncoated blade responses. This could be vital to the improvement of aerodynamic performance and structural durability.

### EXAMPLE NO. 2

### Two Large Gas Turbine Engine Compressor Blades, Uncoated & Coated, Coating Thickness: 0.003 Inch

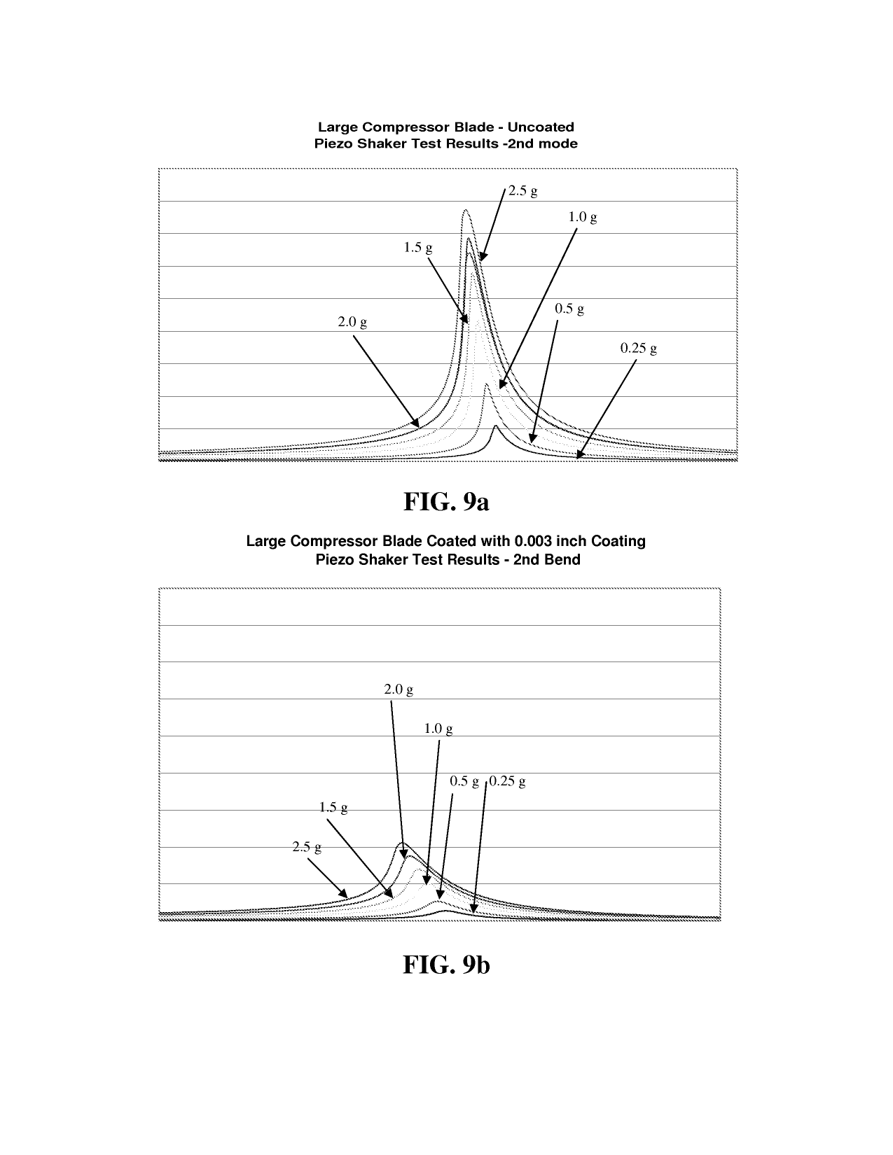

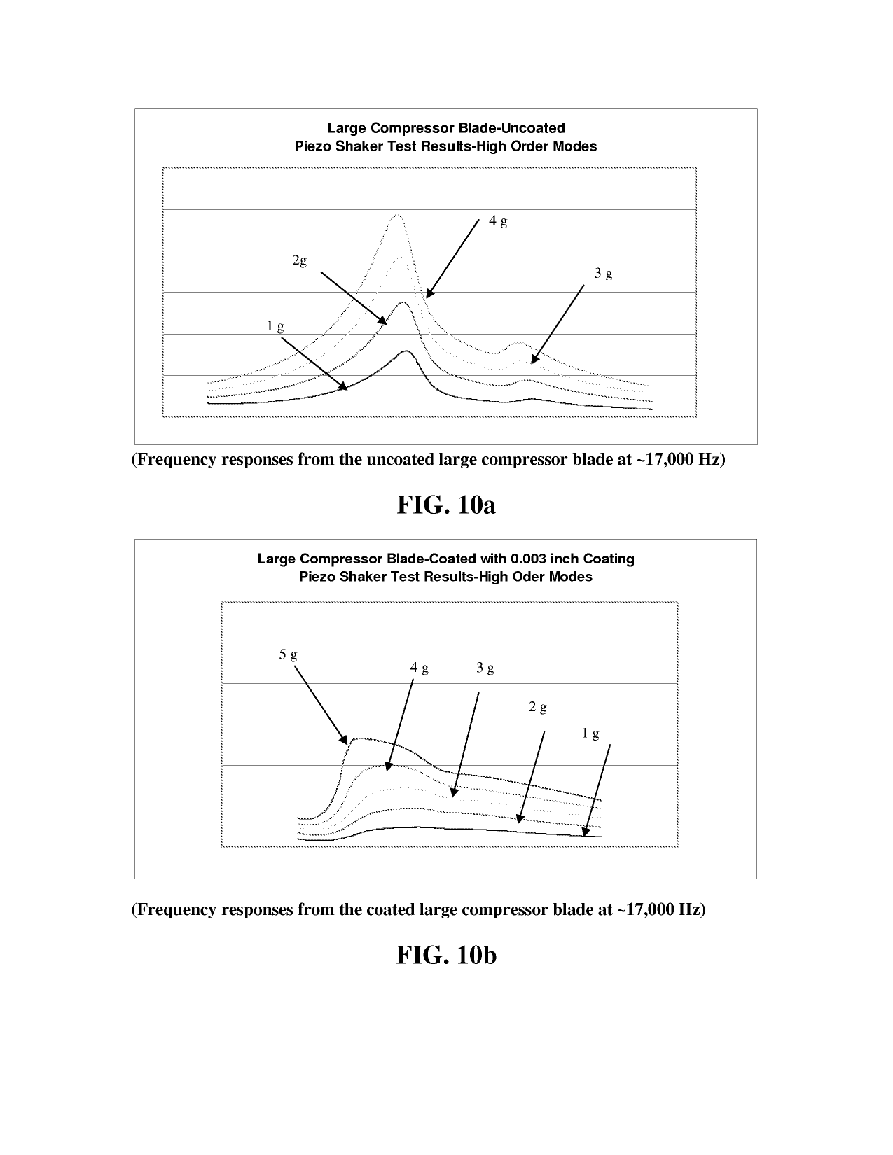

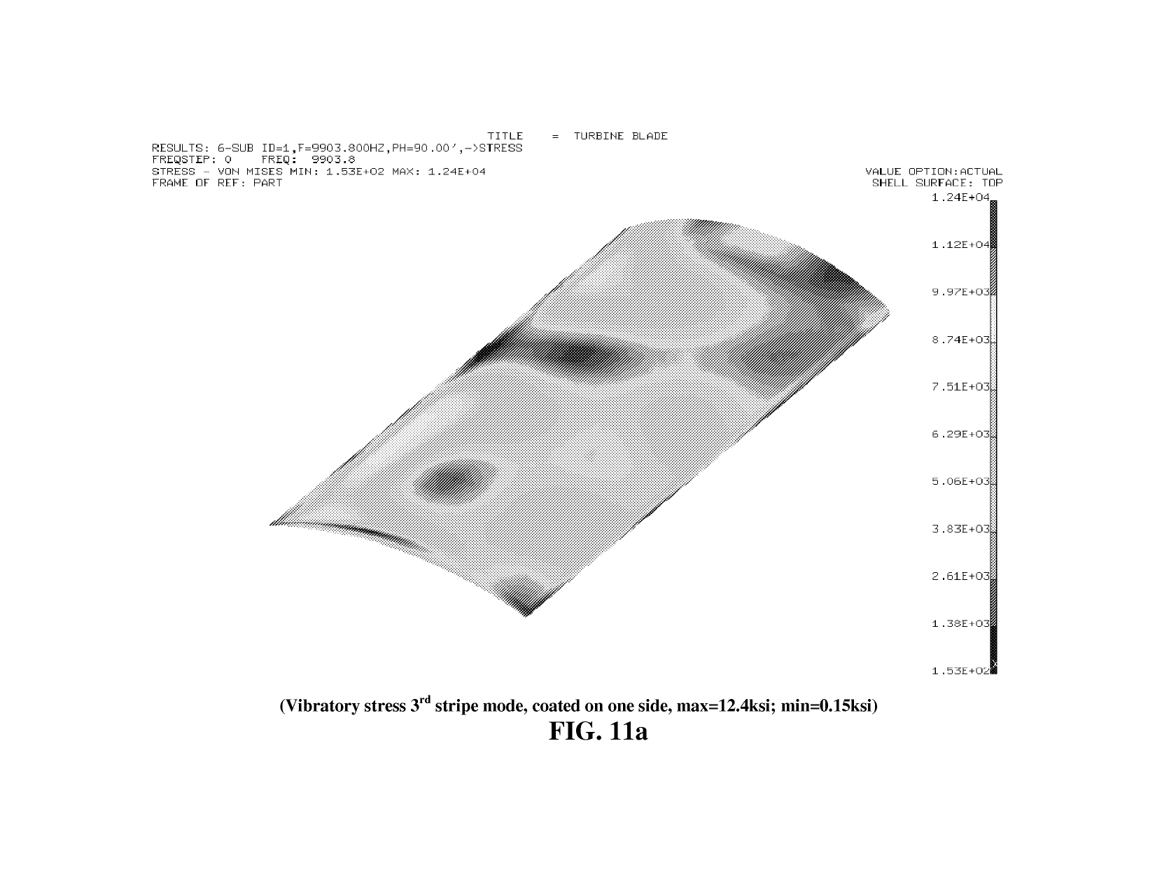

The above successful results have been confirmed and demonstrated on a larger compressor blade from a jet fighter engine. A series of tests were conducted on the coated blades plasma sprayed with a thin coating layer: 0.003 inch thick coating layer and subjected to high accelerations (high “g”), the ones would expect under real-world operating conditions. Using the testing procedure described above, the dynamic responses (frequency, damping, and vibratory strain) of the coated blades have been accomplished using the 18,000 lb. dynamic shaker and the Piezo shaker systems. In order to characterize and identify the damping properties of the blades, approximately 100 test runs were conducted on coated and uncoated compressor blades at various accelerations (“g” levels). These test results of a lower order mode (2^{nd} bending mode), as shown in FIG. 9, and one high order mode (˜17,000 Hz), shown in FIG. 10, have been evaluated, examined, and analyzed. The test results of the frequency responses by the Piezo shaker and the 18,000 lb. dynamic shaker are similar to the beam and compressor blade cases studied previously. The results of lower order modes are very promising as the laser response (related to blade displacement or vibratory stress) at the leading edge tip corner of the coated blade was reduced by approximately half (40-50% reduction) and its damping capability was approximately doubled (80-100% improvement).

This invention is expected to enhance the readiness of aircraft powered by gas turbine engines and significantly reduce the multi-billion dollar annual costs of fatigue preventative maintenance.

### Development of a Novel Finite Element Based Analysis and Design Tool.

In order to implement the free layer damping coating technology to real world applications and productions, an adequate analytical tool will be needed by the design group. Unfortunately, the current capabilities/tools in gas turbine design to conduct analysis with consideration of stress-strain depended high damping do not exist, especially in a high speed rotating condition where bending as well as axial stress states occur simultaneously. Hence, a finite element based analytical procedure has been developed in this invention for modeling the dynamic behavior of beams or blades coated with a thin-layer of Fe—Cr based coating. The strain/stress and temperature dependent damping characteristics/properties were integrated in the finite element model allowing for a temperature dependent forced response evaluation under non-rotating as well as rotating operating conditions. This procedure can be easily extended to a real turbine blading system and a brisk (an integrally bladed rotor) and also account for the effects of centrifugal- and thermo-loading.

The development of the finite element tool has been conducted in this invention to illustrate a general design and analysis procedure for predicting dynamic behavior and damping capability of gas turbine blades coated with magnetomechanical coating layers. The goal in the case study is to investigate the feasibility of using the magnetomechanal coating for enhancing damping at the high order modes, such as third and fourth stripe modes, as shown in FIG. 1, which are typical of actual hardware high cycle fatigue vibrations for which traditional dampers have difficulty achieving the desired stress reduction. The uniform blade is made of Ti-6Al-4V, having dimensions: 3.0 inches wide, 7.0 inches long and 0.4 inches average thickness. The aspect ratio of the blade (1.75) was higher than some modern blade designs, but resulted in frequencies and mode shapes similar to a real blade. The thickness of the coating was chosen to be 0.016 inches (0.008 inch if it is coated on both surfaces of the blades), which is about 4% of the blade's average thickness. Even though adding the coating layer on the pressure side of blade can reduce displacement significantly, eliminating the high stress for high cycle fatigue prevention is of primary interest. Therefore, only stress distributions of the high order modes, the third and fourth stripe modes, of coated and uncoated blades under 0 and 10,000 rpm are presented and examined.

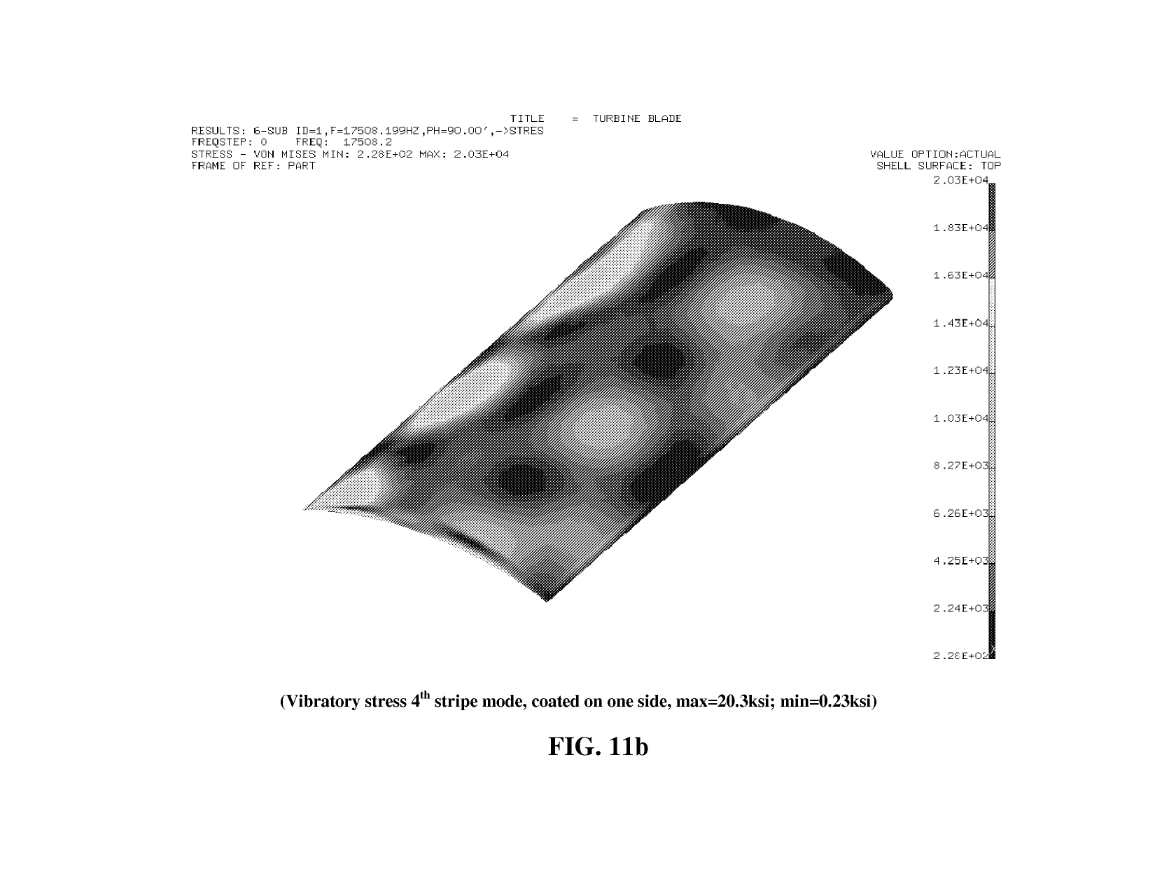

Consider the case of the blade under a concentrated external harmonic excitation force applied at the tip portion of the blade. The magnitudes of the excitation force may be adjusted to achieve a maximum strain of 0.0004. Third stripe mode von Mises stress distributions, as shown in FIG. 11a, of coated blades excited by a 50 lb. force on the central free end of the blades are computed and compared to those of an uncoated blade in FIG. 2a. Observe that the finite element results confirm the experimental predictions that high vibratory stresses are produced at high stripe modes.

One should note that the maximum vibratory stress, as expected, occurs near the trailing and clamped edges of the blade and shows significant reduction in comparison with uncoated blades. Clearly shown in FIG. 11a, the maximum stress of the third stripe vibration mode has been reduced 42.9% by using a magneto-mechanical coating only 4% of the blade's thickness. This leads to the fact that even though the maximum stress of the blade can be as high as 94,400 psi, the majority portion of the blade, as shown in FIG. 11a, responds to a much lower vibratory stress level ranging from 400-6000 psi, which in fact is an ideal stress level for triggering the irreversible movement of magnetic domain boundaries of the coating material.

Similar to the third strip mode, the 4% thickness coating was able to suppress the maximum von Mises stress on the fourth stripe mode from 22.4 ksi to 20.3 ksi (by about 10%), as shown in FIG. 11b. It is important to note that, in accordance with the stress distributions of the third and the fourth stripe modes, zero stress appears near the clamped edge of the blade and maximum stress can be found near the tip of the blade. This indicates that the vibratority stress of these high order modes cannot be reduced by the traditional friction dampers. Another important observation on the fourth stripe mode response, unlike the third stripe mode, is that the vibratory stress on entire blade shows either small or zero. This motionless vibration mode, as expected, triggered less domain walls movement and therefore produces less additional damping to the fourth mode motion. In other words, the differences in stress reductions between the third and fourth stripe modes can be explained by nothing other than that a poor (in the sense of ability to trig the damping down wall movement) strain or stress pattern is produced in the fourth stripe mode vibration. However, fourth stripe mode of real engine blades, which have a twisted non-uniform cross-section, are expected to have much better stress patterns to produce active domain wall movements and hence higher damping. High order modes test data from the compressor blades, as presented in FIGS. 6-8 and 10, confirms this accordingly.

Demonstration and Evaluation of the Capability of the Coating System in the Resistance to Fatigue

As stated above, the mechanical property of the damping alloy was determined in accordance with an ASTM standard testing procedure, which shows a close match to the mechanical properties of metallic materials of gas turbine materials, such as Ti-6Al-4V. This suitable matching between the surface damping coating material and the blade material has the advantage of being able to produce good bonding strength without diluting axial fatigue strength and may be improving bending fatigue strength in the interface during the coating process. Thus, in order to verify these observations, a series of extensive analytical-experimental evaluations and assessments have been conducted in this invention on axial as well as bending fatigue strengths and high cycle survivability of the damping coating systems.

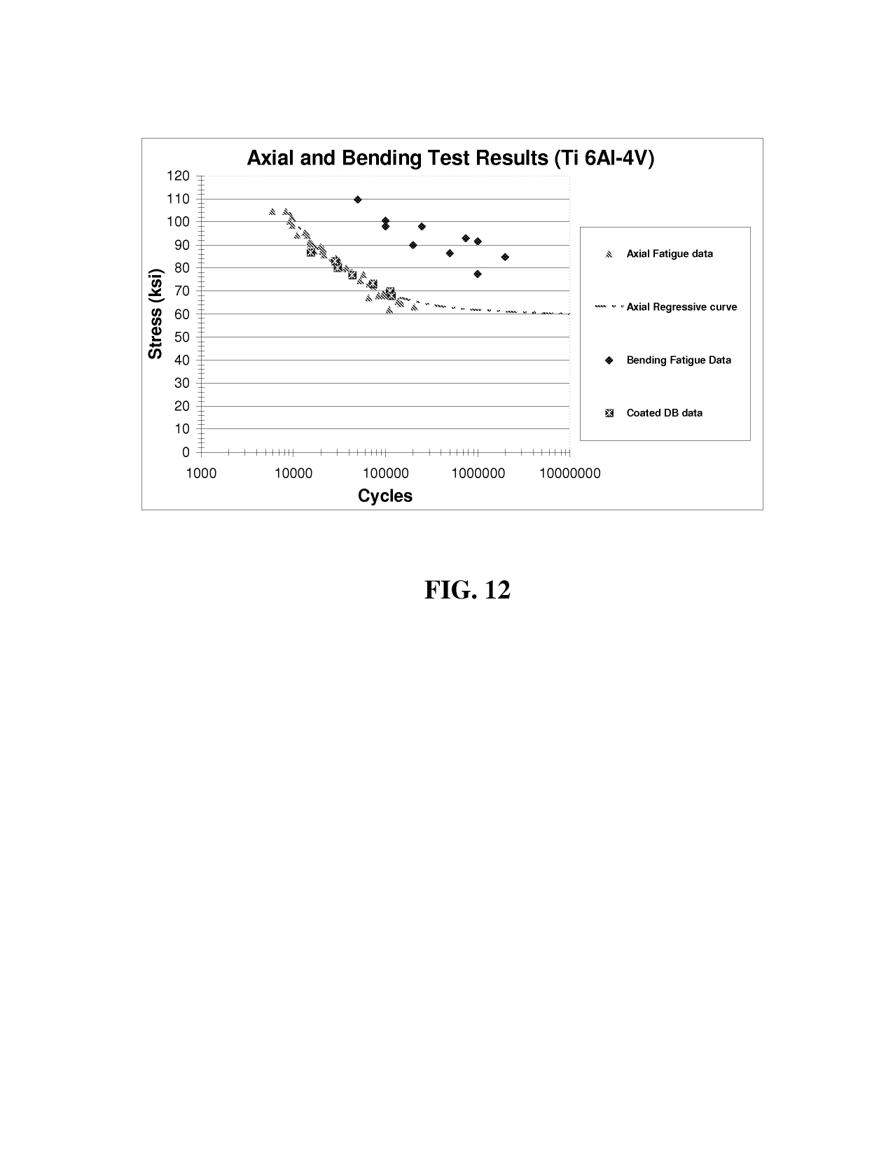

The axial (tension-comparison) fatigue strength of the coating was evaluated by the experimental results from dog-bone Ti-6Al-4V specimens coated with a thin layer of Fe—Cr—X coating (0.002 inches). All the fatigue experiments were conducted at room temperature using a MTS Systems Corporation servo hydraulic load frame. The dog-bone specimen was held in place with hydraulic grips and a cyclic axial force applied at a frequency between 15-40 hertz (Hz). The fatigue limit strength in the tests was determined as the stress for the number of total cycles (10⁴−5×10⁵) at which complete failure occurs. A total of thirty two uncoated and seven coated dog-bone fatigue data were achieved and used to construct the S-N curves for determining axial fatigue limits at a stress ratio=−1 (fully reverse cyclic axial force). The S-N curves, as presented in FIG. 12, show commendable comparison indicating no change in fatigue strength between coated and uncoated dog-bones in low as well as in high cycle ranges.

In order to make sure that we can implement the technology to real world applications, the inventor further extended the study to bending fatigue which often occurs on real aircraft engine components that are subjected to bending loading over a wide range of cyclic frequencies including short wave length bending modes such as third and fourth stripe modes as shown in FIGS. 1, 2, and 11. In our first task, fatigue data was acquired from the bending fatigue coated and uncoated beam specimens. The specimen is 6.15″×0.75″×0.095″; Hastelly X beams coated with coating layer with thickness=0.0055″ on the upper and lower surfaces. Bending tests were conducted with the 6,000 lb. electrodynamic shaker located in the Turbine Engine Fatigue Facility. The test specimens were mounted cantilevered to the shaker head. A forced vibration was then conducted on the specimens at second mode. The fatigue limit of the coated and uncoated beams at 106 fatigue cycles was determined to be the following: uncoated beam bending fatigue limit=33 ksi and coated beam fatigue limit=37 ksi. The bending fatigue limit of the coated beam is approximately 10% higher than that of the uncoated beam.

In addition to beam specimens, further investigation in bending fatigue was also conducted on plate specimens. Bending fatigue data were acquired from 0.125 inch thick Ti-6Al-4V plates (4.5 by 6.5 inches with a clamp area of 2 by 4.5 inches) and coated on both sides with a thin layer (thickness=0.003 inches) of the Fe—Cr—X coating. Bending tests were conducted with the 18,000 lb. electrodynamic shaker located in the Turbine Engine Fatigue Facility. The test specimen was mounted cantilevered to the shaker head. A forced vibration was then conducted on the specimen at two-stripe mode (the mode shape that contains two nodal lines with frequency range: 1600 Hz-1700 Hz). Pre-test forced response finite element analyses were performed to calculate the vibratory stress and strain fields corresponding to the two-stripe mode shape. The vibratory stress pattern of the plate specimen during two-stripe mode is similar to the stress pattern in a high frequency mode (e.g. 3rd or 4th stripe mode) which is generally encountered during high cycle fatigue failure in aeroengine components.

A total of ten uncoated Ti-6Al-4V plate specimens have been fatigued to the point of fracture in accordance with the step method with stress ratio R=−1. In each case, the test run was stopped after a small crack with size around 0.5-1.0 mm was observed, as expected for the two-stripe mode, from the center of the free edge, opposite the clamped edge of the cantilevered plate. Using the step test method, seven data points for the fatigue limit stress at 2.5×10⁴ to 5.0×10⁶ cycles have been obtained. The acquired bending fatigue results are also presented in FIG. 12 for comparison. A comparison between the resulting axial (uncoated Ti-6Al-4V dog-bones) and the bending fatigue (uncoated Ti-6Al-4V plates) data illustrates that, due to the difference in the stress gradient through the thickness for each respective uniaxial procedure, the fatigue limit of bending is approximately 20%-30% higher than tension/compression at each respective fatigue life/cycles.

All together, more than three test runs on coated plate specimens were conducted. Several interesting observations have been made from this investigation: First, much higher shaker driving force was needed for generating the same vibratory stress level for coated plates as for the uncoated ones. This indicates that the vibratory stresses of the coated plates were significantly reduced or suppressed at the two-stripe mode due to the addition damping contributed from the damping coating layers. In turn, during the test runs, approximately 40% higher shaker driving force was imposed to generate desired fatigue limit stress, such as 77.4 ksi at 10⁶ cycles. Second, surprisingly, no single fatigue crack was able to be initiated at the maximum shaker capability: ˜130 g on the first two test runs. Even though the maximum vibration stress on each test run had already reached to as high as 102 Ksi, which is about 31% higher than the fatigue limit stress, 77.4 Ksi of the uncoated plate, no fatigue cracks were found during the test duration. This indicates that the bending fatigue limit of the coated Ti-6Al-4V can be much higher than the uncoated one at high frequency stripe modes vibration. However, after improving the fixer design, the third coated plate was fatigued at fatigue limit 121 Ksi which is surprisingly about 55% higher than the fatigue limit (77.4 Ksi) of the uncoated ones.

In conclusion, with the promising results and evidences shown in this invention, it is believed that the free layer coating damping approach works reasonably well without diluting the axial fatigue strength and significantly improved the bending fatigue strength of the substrate material Ti-6Al-4V. This could be vital to the improvement of structural durability and fatigue resistance of the coated blades or IBRs.

What I claim is:

1. Application of a vibration damping magneto-mechanical coating for an article of manufacture having a metal substrate, said coating consisting essentially of: iron (Fe) and chromium (Cr) plus one of the group consisting of aluminum (Al) and molybdenum (Mo), and wherein the coating is at least 0.001 inch.

2. The coating of claim 1, wherein the metal substrate is composed essentially of a metal selected from the group of aluminum, a titanium based alloy, a steel alloy, a nickel alloy, a nickel-based superalloy, and a cobalt alloy.

3. The coating of claim 1, wherein the coating is applied to the substrate by one of the group consisting of thermal spraying and physical vapor deposition processes.

4. The coating of claim 3, wherein the article of manufacture is a rotor component for a turbine gas engine.

5. The coating of claim 1, wherein the coating is a foil adhered to said substrate.

6. The coating of claim 5, wherein the article of manufacture is a rotor component for a turbine gas engine.

7. The coating of claim 1, wherein the coating composition consists essentially of about 16 weight percent Cr and about 0-6 weight percent Al, the remainder being Fe.

8. The coating of claim 1, wherein the coating composition consists essentially of about 16 weight percent Cr and about 0-5 weight percent Mo, the remainder being Fe.

9. A method of vibration damping, comprising the steps of:
providing a metal substrate; and
coating the substrate with a magneto-mechanical coating consisting essentially of iron (Fe) and chromium (Cr) plus one of the group consisting of aluminum (Al) and molybdenum (Mo), and wherein the coating is at least 0.001 inch.

10. The method of claim 9, wherein the metal substrate is composed essentially of a metal selected from the group of aluminum, a titanium based alloy, a steel alloy, a nickel alloy, a nickel-based superalloy, and a cobalt alloy.

11. The method of claim 9, wherein the coating is applied to the substrate by one of the group consisting of thermal spraying and physical vapor deposition processes.

12. The method of claim 11, wherein the article of manufacture is a rotor component for a turbine gas engine.

13. The method of claim 9, wherein the coating is a foil adhered to said substrate.

14. The method of claim 13, wherein the article of manufacture is a rotor component for a turbine gas engine.

15. A method of fatigue strength improvement acting as a damage barrier and to arrest cracks initiated from the substrate, comprising the steps of:
providing a metal substrate; and
coating the substrate with a magneto-mechanical coating consisting essentially of iron (Fe) and chromium (Cr) plus one of the group consisting of aluminum (Al) and molybdenum (Mo), and wherein the coating is at least 0.001 inch.

16. The method of claim 15, wherein the metal substrate is composed essentially of a metal selected from the group of aluminum, a titanium based alloy, a steel alloy, a nickel alloy, a nickel-based superalloy, and a cobalt alloy.

17. The method of claim 15, wherein the coating is applied to the substrate by one of the group consisting of thermal spraying and physical vapor deposition processes.

18. The method of claim 17, wherein the article of manufacture is a rotor component for a turbine gas engine.

19. The method of claim 15, wherein the coating is a foil adhered to said substrate.

20. The method of claim 19, wherein the article of manufacture is a rotor component for a turbine gas engine.

21. A method of finite element based design and analytical tool and method, comprising the steps of:
modeling a metal substrate; and
coating the substrate with a stress or strain induced damping coating

22. The method of claim 21, wherein the metal substrate is composed essentially of a metal selected from the group of aluminum, a titanium based alloy, a steel alloy, a nickel alloy, a nickel-based superalloy, and a cobalt alloy.

23. The method of claim 21, wherein the coating is applied to the substrate by one of the group consisting of thermal spraying and physical vapor deposition processes.

24. The method of claim 23, wherein the article of manufacture is a rotor component for a turbine gas engine.

25. The method of claim 21, wherein the coating is a foil adhered to said substrate.

26. The method of claim 25, wherein the article of manufacture is a rotor component for a turbine gas engine.
